(19) United States
(12) Patent Application Publication
(10) Pub. No.: US 2017/0168355 A1
(43) Pub. Date: Jun. 15, 2017

(54) LIQUID CRYSTAL DISPLAY AND MANUFACTURING METHOD THEREOF

(71) Applicant: Samsung Display Co., Ltd., Yongin-si (KR)

(72) Inventors: Hee-Keun LEE, Suwon-si (KR); Myeong Hee KIM, Yongin-si (KR); Han Joon YOO, Seoul (KR); Dae Ho LEE, Seoul (KR)

(21) Appl. No.: 15/231,575

(22) Filed: Aug. 8, 2016

(30) Foreign Application Priority Data
Dec. 9, 2015 (KR) 10-2015-0175200

(51) Int. Cl. G02F 1/1337; G02F 1/1333; G02F 1/1343

(52) U.S. Cl. CPC G02F 1/133784; G02F 1/1337; G02F 1/134309; G02F 1/133345; G02F 2201/121; G02F 2201/123

(57) ABSTRACT

A liquid crystal display according to an exemplary embodiment of the inventive concept includes: a first alignment layer disposed on a first substrate; a second substrate facing the first substrate; a liquid crystal layer disposed between the first substrate and the second substrate; and a second alignment layer disposed between the liquid crystal layer and the second substrate, wherein a surface of at least one of the first alignment layer and the second alignment layer may be provided with a plurality of grooves, and a width of each the grooves may be in a range of about 0.05 to about 20.00 μm.

### CROSS-REFERENCE TO RELATED APPLICATION

This application claims priority to and the benefit of Korean Patent Application No. 10-2015-0175200 filed in the Korean Intellectual Property Office on Dec. 9, 2015, the entire contents of which are incorporated herein by reference.

### BACKGROUND

(a) Technical Field

The present disclosure relates to a liquid crystal display (LCD) and a manufacturing method thereof.

(b) Description of the Related Art

A liquid crystal display is a widely used display device, which typically consists of a pair of substrates and a liquid crystal layer interposed between the substrates.

By applying voltages to electrodes formed on a display panel which includes the substrates, an electric field is generated in the liquid crystal layer, and alignment of liquid crystal molecules of the liquid crystal layer is determined under the influence of the generated electric field so as to display images by controlling the polarization of incident light. Uniformity of alignment of the liquid crystal molecules is the most important factor in determining image quality of the liquid crystal display.

A general method of aligning a liquid crystal in the prior art includes a rubbing method, wherein a polymer film such as a polyimide is applied on a substrate such as a glass substrate, and the applied surface is rubbed in a certain direction with a fiber such as nylon, cotton, rayon, or polyester. However, the rubbing method may generate fine dust or static electricity when a fiber and a polymer film are rubbed, which may cause a serious problem when manufacturing a liquid crystal panel.

The above information disclosed in this Background section is only to enhance the understanding of the background of the invention and therefore it may contain information that does not form the prior art that is already known in this country to a person of ordinary skill in the art.

### SUMMARY

The inventive concept has been made in an effort to provide a liquid crystal display and a manufacturing method thereof that can densely and uniformly align liquid crystal molecules.

An exemplary embodiment of the inventive concept provides a manufacturing method of a liquid crystal display, including: forming an alignment layer on a substrate; and rubbing a surface of the alignment layer with a plurality of metal particles.

The rubbing of the surface of the alignment layer with the plurality of metal particles may be performed within a magnetic field

The rubbing of the surface of the alignment layer with the plurality of metal particles may include forming a plurality of grooves on the surface of the alignment layer.

At least one of the metal particles may have a diameter of about 0.05 to about 20.00 μm.

At least one of the metal particles may include a ferromagnetic material.

At least one of the metal particles may include at least one of iron, nickel, cobalt, iron oxide, chromium oxide, and ferrite.

At least one of the metal particles may be coated for insulation.

The rubbing of the surface of the alignment layer with the plurality of metal particles may include moving a magnetic field generating member generating a magnetic field along a first rubbing direction.

The rubbing of the surface of the alignment layer with the plurality of metal particles may further include moving the magnetic field generating member in a second rubbing direction.

The forming of the alignment layer on the substrate may include forming a first alignment layer on a first substrate and forming a second alignment layer on a second substrate, the rubbing of the surface of the alignment layer with the plurality of metal particles may include rubbing a surface of the first alignment layer with the plurality of metal particles and rubbing a surface of the second alignment layer with the plurality of metal particles, and the manufacturing method of the liquid crystal display may further include disposing the first substrate and the second substrate to face each other and forming a liquid crystal layer between the first substrate and the second substrate.

The manufacturing method of the liquid crystal display may further include: forming a sacrificial layer on the substrate; forming a roof layer on the sacrificial layer; forming a plurality of spaces between the substrate and the roof layer by removing the sacrificial layer; forming the alignment layer by injecting an alignment material into the plurality of spaces; and forming a liquid crystal layer by injecting liquid crystal molecules into the plurality of spaces, wherein the rubbing of the surface of the alignment layer with the plurality of metal particles may be performed before the forming of the liquid crystal layer.

Another embodiment of the inventive concept provides a liquid crystal display including: a first alignment layer disposed on a first substrate; a second substrate facing the first substrate; a liquid crystal layer disposed between the first substrate and the second substrate; and a second alignment layer disposed between the liquid crystal layer and the second substrate, wherein a surface of at least one selected from the first alignment layer and the second alignment layer may be provided with a plurality of grooves, and a width of at least one of the grooves may be in a range of about 0.05 to about 20.00 μm.

The width of the at least one of the grooves may be equal to or less than a cell gap of the liquid crystal layer.

The surface of the first alignment layer and the surface of the second alignment layer may each have at least one groove, and a width of the at least one groove of the surface of the first alignment layer may be different from a width of the at least one groove of the surface of the second alignment layer.

The liquid crystal display may further include: a first electrode disposed on the first substrate; and a second electrode spaced apart from the first electrode; and an insulating layer between the first electrode and the second electrode.

Each of the grooves may have a uniform width.

Yet another embodiment of the inventive concept provides a liquid crystal display, including: a first alignment layer disposed on a substrate; a second alignment layer overlapping the first alignment layer; a roof layer disposed on a second alignment layer; and a liquid crystal layer including liquid crystal molecules disposed in a plurality of spaces between the first alignment layer and the second alignment layer, wherein a surface of at least one selected from the first alignment layer and the second alignment layer may have a plurality of grooves.

A width of at least one of the grooves may be in a range of about 0.05 to about 20.00 μm.

The width of the at least one of the grooves may be equal to or less than a cell gap of the liquid crystal layer.

The surface of the first alignment layer and the surface of the second alignment layer may each have at least one groove, and a width of the at least one groove of the surface of the first alignment layer may be different from a width of the at least one groove of the surface of the second alignment layer.

The width of the at least one groove of the surface of the first alignment layer may be greater than the width of the at least one groove of the surface of the second alignment layer.

The roof layer may be a first roof layer defining a first space of the plurality of spaces, and a second roof layer may be adjacent to the first roof layer defining a second space of the plurality of spaces, and a trench may be formed between the first space and the second space, and metal particles may be positioned in the trench.

The liquid crystal display may further include a capping layer disposed on the roof layer, wherein the capping layer covers the trench.

The liquid crystal display may further include a common electrode disposed on the substrate, and a pixel electrode spaced apart from the common electrode and an insulating layer disposed between the pixel electrode and the common electrode.

According to the embodiments of the inventive concept, it is possible to densely and uniformly align liquid crystal molecules.

### BRIEF DESCRIPTION OF THE DRAWINGS

FIG. 1 illustrates a cross-sectional view of a liquid crystal display including an alignment layer according to an exemplary embodiment of the inventive concept.

FIG. 2 illustrates a schematic perspective view of a lower panel of the liquid crystal display of FIG. 1.

FIG. 3 illustrates a top plan view of a liquid crystal display according to an exemplary embodiment of the inventive concept.

FIG. 4 illustrates a cross-sectional view of FIG. 3 taken along line IV-IV.

FIG. 5 illustrates a flowchart of a manufacturing method of a liquid crystal display according to an exemplary embodiment of the inventive concept.

FIG. 6 to FIG. 8 are a perspective view and cross-sectional views illustrating a step of rubbing with metal particles included in a manufacturing method of a liquid crystal display according to an exemplary embodiment of the inventive concept, respectively.

FIG. 9 illustrates a schematic perspective view of a step of rubbing with a rubbing fabric in a conventional liquid crystal display.

FIG. 10 illustrates a top plan view of a liquid crystal display according to an exemplary embodiment of the inventive concept.

FIG. 11 illustrates a cross-sectional view of FIG. 10 taken along line A-A.

FIG. 12 illustrates a cross-sectional view of FIG. 10 taken along line B-B.

FIG. 13 illustrates a partial enlarged view of FIG. 12.

FIG. 14 illustrates a flowchart of a manufacturing method of a liquid crystal display according to an exemplary embodiment of the inventive concept.

FIG. 15 to FIG. 20 illustrate cross-sectional views of a manufacturing method of a liquid crystal display according to an exemplary embodiment of the inventive concept, respectively.

FIG. 21 illustrates an exemplary view of a manufacturing apparatus for performing a manufacturing method of a liquid crystal display according to an exemplary embodiment of the inventive concept.

FIG. 22 illustrates a cross-sectional view of a modified embodiment with respect to the exemplary embodiment of FIG. 10 to FIG. 13.

### DETAILED DESCRIPTION OF THE EMBODIMENTS

The inventive concept will be described more fully hereinafter with reference to the accompanying drawings, in which exemplary embodiments of the invention are shown. As those skilled in the art would realize, the described embodiments may be modified in various different ways, all without departing from the spirit or scope of the inventive concept.

Parts that are irrelevant to the description will be omitted to clearly describe the inventive concept, and like reference numerals designate like elements throughout the specification.

Furthermore, in the drawings, the size and thickness of each element are arbitrarily illustrated for ease of description, and the inventive concept is not necessarily limited to those illustrated in the drawings. In the drawings, the thickness of layers, films, panels, regions, etc., are exaggerated for clarity.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

Furthermore, throughout the specification, the phrase “on a plane” means viewing a target portion from the top, and the phrase “on a cross-section” means viewing a cross-section formed by vertically cutting a target portion from the side.

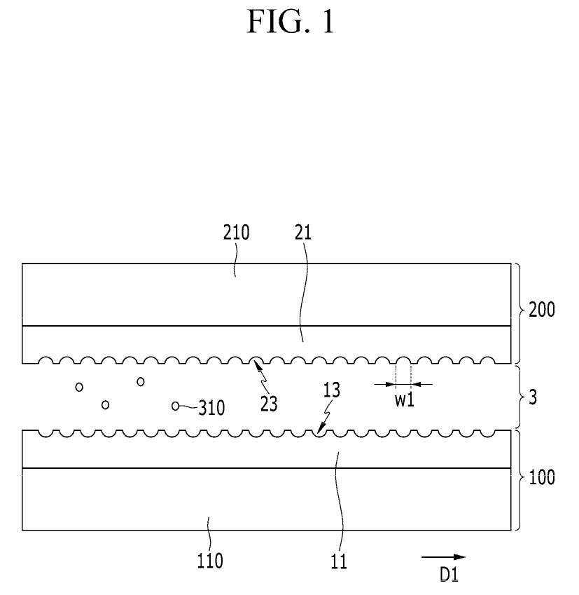

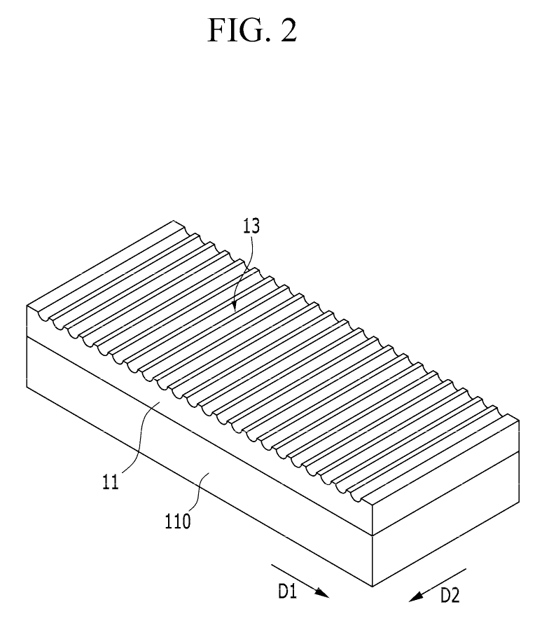

FIG. 1 illustrates a cross-sectional view of a liquid crystal display including an alignment layer according to an exemplary embodiment of the inventive concept. FIG. 2 illustrates a schematic perspective view of a lower panel of the liquid crystal display of FIG. 1.

Referring to FIG. 1, a liquid crystal display according to an exemplary embodiment of the inventive concept includes a lower panel 100 including a first substrate 110 and a first alignment layer 11, an upper panel 200 including a second substrate 210 and a second alignment layer 21, and a liquid crystal layer 3 disposed between the lower panel 100 and the upper panel 200. The liquid crystal layer 3 includes a plurality of liquid crystal molecules 310.

The first alignment layer 11 is disposed on the first substrate 110, and the second alignment layer 21 is disposed between the second substrate 210 and the liquid crystal layer 3. At least one of a surface of the first alignment layer 11 facing the liquid crystal layer 3 and a surface of the second alignment layer 21 facing the liquid crystal layer 3 is provided with a plurality of grooves 13 or 23. In FIG. 1, although it is described that both the surface of the first alignment layer 11 and the surface of the second alignment layer 21 is provided with the grooves 13 and 23, respectively, only one of either of them may be provided with the grooves.

In the grooves 13 and 23 formed on the surfaces of the first and second alignment layers 11 and 21, respectively, the liquid crystal molecules 310 may be aligned in a predetermined direction.

The grooves 13 and 23 according to the present exemplary embodiment may have a first width w1. The first width w1 may be in a range of about 0.05 to about 20.00 μm. In a modified exemplary embodiment, the first width w1 may be equal to or less than a cell gap of the liquid crystal layer 3. A width of the groove 13 of the surface of the first alignment layer 11 may be different from a width of the groove 23 of the surface of the second alignment layer 21. The cell gap may be referred to as a thickness or height of the liquid crystal layer 3, or a gap between the first alignment layer 11 and the second alignment layer 21.

Referring to FIG. 1 and FIG. 2, a direction defining the width w1 of the groove may be defined as a first direction D1, and a direction crossing the first direction D1 may be defined as a second direction D2. In FIG. 2, it is illustrated that the first direction D1 and the second direction D2 perpendicularly cross each other, but the inventive concept is not limited thereto, and the first direction D1 and the second direction D2 may cross each other at angles other than a right angle.

As shown in FIG. 2, the plurality of grooves 13 according to the present exemplary embodiment substantially extend parallel to the second direction D2. In FIG. 2, only the grooves 13 of the surface of the first alignment layer 11 are illustrated, but a plurality of grooves 23 of the surface of the second alignment layer 21 may substantially extend parallel to the second direction D2. The plurality of grooves 13 according to the present exemplary embodiment may have a substantially uniform width.

Hereinafter, the liquid crystal display including the alignment layer according to the exemplary embodiment of the inventive concept that is described above will be described more fully.

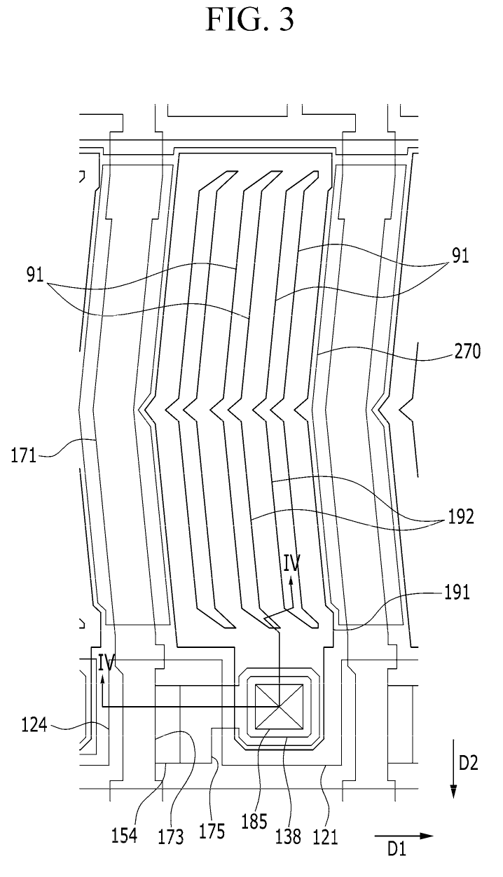

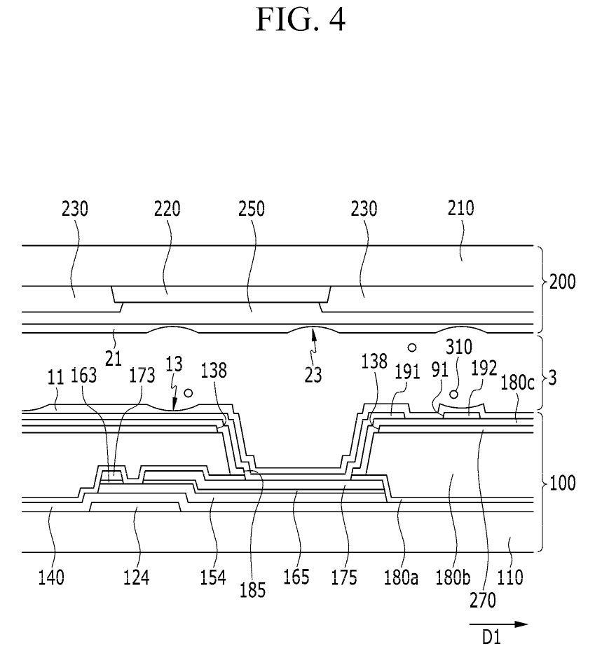

FIG. 3 illustrates a top plan view of a liquid crystal display according to an exemplary embodiment of the inventive concept. FIG. 4 illustrates a cross-sectional view of FIG. 3 taken along line IV-IV.

Referring to FIG. 3 and FIG. 4, the liquid crystal display according to the present exemplary embodiment includes the lower panel 100 and the upper panel 200 facing each other, and the liquid crystal layer 3 disposed between the lower panel 100 and the upper panel 200.

First, the lower panel 100 will be described.

A gate conductor including a gate line 121 is disposed on the first substrate 110 which is made of transparent glass, plastic, or the like.

The gate line 121 may include a gate electrode 124, and a wide end portion (not shown) to be connected to another layer or an external driving circuit. The gate line 121 may be made of aluminum-based metals such as aluminum (Al) or an aluminum alloy, silver-based metals such as silver (Ag) or a silver alloy, copper-based metals such as copper (Cu) or a copper alloy, molybdenum-based metals such as molybdenum (Mo) or a molybdenum alloy, chromium (Cr), tantalum (Ta), and titanium (Ti). However, the gate line 121 may have a multilayer structure including at least two conductive layers having different physical properties.

A gate insulating layer 140 is disposed on the gate line 121, and the gate insulating layer 140 is made of a silicon nitride (SiNx), a silicon oxide (SiOx), etc. The gate insulating layer 140 may have a multilayer structure including at least two insulating layers having different physical properties.

A semiconductor layer 154 made of amorphous silicon or polysilicon is disposed on the gate insulating layer 140. The semiconductor layer 154 may be made of an oxide semiconductor.

Ohmic contacts 163 and 165 are disposed on the semiconductor layer 154. The ohmic contacts 163 and 165 may be made of a material such as n+ hydrogenated amorphous silicon in which an n-type impurity such as phosphorus is doped at a high concentration, or of a silicide. The ohmic contacts 163 and 165 may be disposed on the semiconductor layer 154. When the semiconductor layer 154 is an oxide semiconductor, the ohmic contacts 163 and 165 may be omitted.

A data line 171 including a source electrode 173 and a data conductor including a drain electrode 175 are disposed on the ohmic contacts 163 and 165 and the gate insulating layer 140.

The data line 171 includes a wide end portion (not shown) to be connected to another layer or an external driving circuit. The data line 171 transmits a data signal, and substantially extends in a vertical direction to cross the gate line 121.

In this case, the data line 171 may have curved portions to obtain maximum transmittance of the liquid display device, and the curved portion may meet each other around a middle portion of a pixel area to have a V-shape.

The source electrode 173 may be a part of the data line 171, and may be disposed on the same line as the data line 171. The drain electrode 175 may be disposed to extend parallel to the source electrode 173. Accordingly, the drain electrode 175 is partially parallel to the data line 171.

The gate electrode 124, the source electrode 173, and the drain electrode 175 form one thin film transistor (TFT) together with the semiconductor layer 154, and a channel of the thin film transistor is disposed on the semiconductor layer 154 between the source electrode 173 and the drain electrode 175.

In the liquid crystal display according to the exemplary embodiment of the inventive concept, by including the source electrode 173 disposed on the same line as the data line 171 and the drain electrode 175 extending parallel to the data line 171, a width of the thin film transistor may be increased without increasing an area occupied by the data conductor, thereby increasing an aperture ratio of the liquid crystal display.

The data line 171 and the drain electrode 175 may be preferably made of a refractory metal such as molybdenum, chromium, tantalum, titanium, etc., or an alloy thereof, and may have a multilayer structure in which a refractory metal layer (not shown) and a low resistance conductive layer (not shown) are included. Examples of the multilayer structure may include a double layer of a chromium or molybdenum (alloy) lower layer and an aluminum (alloy) upper layer, a double layer of a titanium lower layer and a copper upper layer, and a triple layer of a molybdenum (alloy) lower layer, an aluminum (alloy) middle layer, and a molybdenum (alloy) upper layer.

A first passivation layer 180a is disposed on the data conductors 171, 173, and 175, the gate insulating layer 140, and an exposed portion of the semiconductor layer 154. The first passivation layer 180a may be made of an organic insulating material, an inorganic insulating material, or the like.

A second passivation layer 180b is disposed on the first passivation layer 180a. The second passivation layer 180b may be made of an organic insulating material.

The second passivation layer 180b may be a color filter. When the second passivation layer 180b is the color filter, the second passivation layer 180b may uniquely display one of primary colors, and the primary colors may be, for example, three primary colors, such as red, green, and blue, or yellow, cyan, magenta, etc. Though not illustrated, an additional color filter for displaying mixed colors of the primary colors or white as well as the primary colors may be further included. When the second passivation layer 180b is the color filter, a color filter 230 may be omitted in the upper display substrate 200 to be described below. Unlike the present exemplary embodiment, the second passivation layer 180b may be made of an organic insulating material, and the color filter (not shown) may be formed between the first and second passivation layers 180a and 180b.

A common electrode 270 is disposed on the second passivation layer 180b. The common electrode 270 may be substantially disposed as a whole plate on an entire surface of the substrate 110 while having a planar shape, and is provided with an opening 138 disposed in a region corresponding to a periphery of the drain electrode 175. For example, the common electrode 270 may have a plate-like planar shape.

Common electrodes 270 disposed at adjacent pixels are connected to each other to receive the constant common voltage that is supplied from the outside of a display area.

An insulating layer 180c is disposed on the common electrode 270. The insulating layer 180c may be made of an organic insulating material, an inorganic insulating material, or the like.

A pixel electrode 191 is disposed on the insulating layer 180c. The pixel electrode 191 has a curved edge that is substantially parallel to the curved portion of the data line 171. The pixel electrode 191 may have a plurality of cutouts 91, and a plurality of branched electrodes 192 which are disposed between neighboring cutouts.

The pixel electrode 191 is a first field generating electrode or a first electrode, and the common electrode 270 is a second field generating electrode or a second electrode. The pixel electrode 191 and the common electrode 270 may generate a fringe field and the like.

A contact hole 185 exposing the drain electrode 175 is disposed in the first passivation layer 180a, the second passivation layer 180b, and the insulating layer 180c. The pixel electrode 191 is physically and electrically connected to the drain electrode 175 via the contact hole 185, and receives a voltage from the drain electrode 175.

The first alignment layer 11 is disposed on the pixel electrode 191 and the insulating layer 180c. The first alignment layer 11 may be a horizontal alignment layer. If the liquid crystal molecules 310 are aligned on the horizontal alignment layer when an electric field is not applied to the horizontal alignment layer, a long axis of the liquid crystal molecules may lie in a direction substantially parallel to the first substrate 110.

In the present exemplary embodiment, the surface of the first alignment layer 11 includes the plurality of grooves 13 extending in the second direction D2 that is substantially the same as a direction in which the data line 171 extends. Widths of grooves 13 may be in a range of about 0.05 to about 20.00 μm, or may be equal to or less than the cell gap of the liquid crystal layer 3. The cell gap may be referred to as the thickness or height of the liquid crystal layer 3, or as the gap between the first alignment layer 11 and the second alignment layer 21. The width of the plurality of grooves 13 may be substantially uniform. Since the plurality of grooves 13 are formed by using metal particles described later, the surface of the alignment layer may be formed to have more uniform grooves than when the plurality of grooves are formed by using a conventional rubbing fabric.

The upper panel 200 will now be described.

The upper panel 200 is positioned to face the first substrate 110, and includes the second substrate 210 made of transparent glass or plastic and a light blocking member 220 disposed between the second substrate 210 and the liquid crystal layer 3. The light blocking member 220 is referred to as a black matrix, and blocks light leakage.

A plurality of color filters 230 are disposed on a surface of the second substrate 210 facing the first substrate 110. When the second passivation layer 180b of the lower panel 100 is a color filter, or when the lower panel 100 is provided with a color filter, the color filter 230 of the upper panel 200 may be omitted. In addition, the lower panel 100 may be provided with the light blocking member 220 of the upper panel 200.

Surfaces of the color filter 230 and the light blocking member 220 facing the first substrate 110 are provided with an overcoat 250. The overcoat 250 may be made of an (organic) insulating material, and it prevents the color filter 230 from being exposed and provides a flat surface. The overcoat 250 may be omitted.

The second alignment layer 21 is positioned between the overcoat 250 and the liquid crystal layer 3. The second alignment layer 21 may be made of the same material as the above-described first alignment layer 11, and may be formed by the above-described method. A surface of the second alignment layer 21 facing the first substrate 110 is provided with a plurality of grooves 23. Widths of the grooves 23 may be in a range of about 0.05 to about 20.00 μm, or may be equal to or less than the cell gap of the liquid crystal layer 3. In this case, the width of the groove 13 of the surface of the first alignment layer 11 and the width of the groove 23 of the surface of the second alignment layer 21 may be the same or may be different.

In the present exemplary embodiment, the liquid crystal layer 3 may include liquid crystal molecules 310 having negative dielectric anisotropy or positive dielectric anisotropy.

The liquid crystal molecules 310 of the liquid crystal layer 3 may be aligned so that a direction of a long axis thereof is parallel to the display panels 100 and 200.

The pixel electrode 191 receives a data voltage from the drain electrode 175, and the common electrode 270 receives a constant common voltage from a common voltage applying portion disposed at the outside of the display area.

The pixel electrode 191 and the common electrode 270 which are the field generating electrodes generate the electric field, and thus the liquid crystal molecules of the liquid crystal layer 3 may rotate in a direction parallel or perpendicular to the direction of the electric field, wherein the liquid crystal molecules are disposed on the two electric field generating electrodes 191 and 270. Depending on the thus-determined rotation direction of the liquid crystal molecules, polarization of light passing through the liquid crystal layer varies.

As such, transmittance of the liquid crystal display may increase and a wide viewing angle may be realized by forming the two field generating electrodes 191 and 270 on one display panel 100.

According to the liquid crystal display of the illustrated exemplary embodiment, the common electrode 270 has the flat planar shape and the pixel electrode 191 has the plurality of branch electrodes, but according to a liquid crystal display of a modified exemplary embodiment, the pixel electrode 191 may have a flat planar shape and the common electrode 270 may have a plurality of branch electrodes.

The inventive concept may be applicable to all other cases in which the two field generating electrodes overlap each other on the first substrate 110 while interposing the insulating layer therebetween, the first field generating electrode formed under the insulating layer has a flat planar shape, and the second field generating electrode formed on the insulating layer has a plurality of branch electrodes.

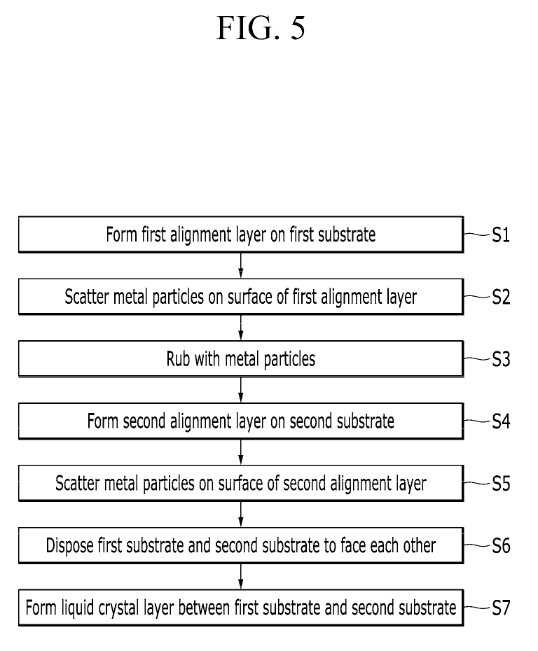

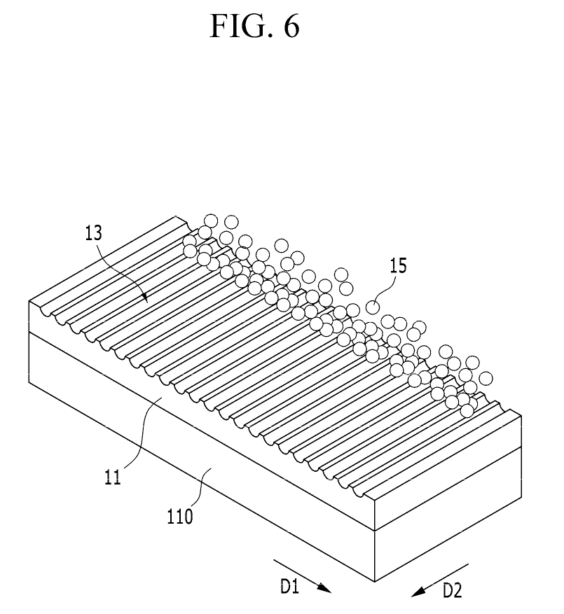

FIG. 5 illustrates a flowchart of a manufacturing method of a liquid crystal display according to an exemplary embodiment of the inventive concept. FIG. 6 to FIG. 8 are a perspective view and cross-sectional views, respectively, illustrating a step of rubbing with metal particles included in a manufacturing method of a liquid crystal display according to an exemplary embodiment of the inventive concept.

Referring to FIG. 5, a manufacturing method of a liquid crystal display according to an exemplary embodiment of the inventive concept includes forming a first alignment layer on a first substrate (S1).

Before the forming of the first alignment layer on the first substrate, a switching element including the above-described thin film transistor, the field generating electrode, the passivation layer, and the like may be formed. For forming the first alignment layer, an alignment material for horizontally aligning the liquid crystal molecules on the first substrate is coated, and the coated alignment material is baked. The baking process may consist of two steps, which are a pre-baking step and a hard-baking step.

The baking process may additionally include a cleaning step.

Next, the manufacturing method of the liquid crystal display according to the present exemplary embodiment includes scattering metal particles on the surface of the first alignment layer (S2).

The metal particles according to the present exemplary embodiment may have a diameter of about 0.05 to about 20.00 μm. In addition, the metal particles of the present exemplary embodiment may include a ferromagnetic material which includes at least one of iron, nickel, cobalt, iron oxide, chromium oxide, and ferrite. The metal particles according to the present exemplary embodiment may be circular or oval. In the present exemplary embodiment, the surfaces of the metal particles may be coated for insulation. For example, the surface of the metal particle may be coated with an insulation material. This allows the metal particles, even though they remain on the surface of the alignment layer, to not be short-circuited to other constituent elements of the liquid crystal display according to the present exemplary embodiment. The ferromagnetic material used in the present exemplary embodiment may have magnetic properties of a material that can be magnetized in the absence of an external magnetic field.

Next, the manufacturing method of the liquid crystal display according to the present exemplary embodiment includes rubbing the surface of the first alignment layer with the metal particles (S3).

Referring to FIG. 6, when a plurality of metal particles 15 move on the surface of the first alignment layer 11 disposed on the first substrate 110 in the second direction D2 while a force is applied to the surface of the first alignment layer 11, the plurality of grooves 13 are formed on the surface of the first alignment layer 11.

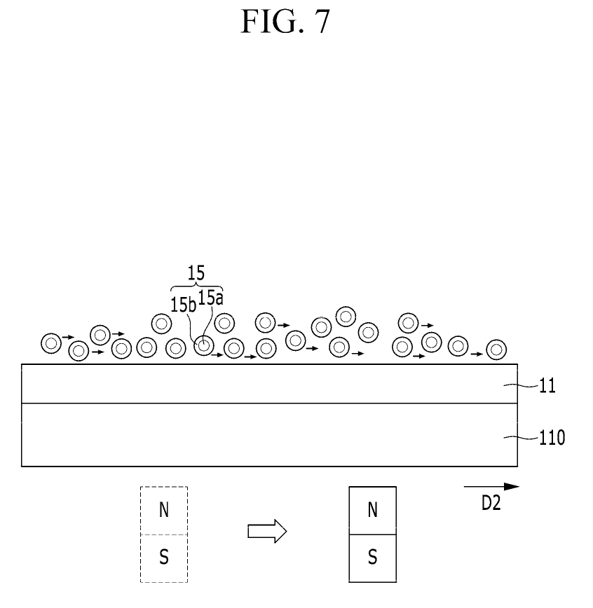

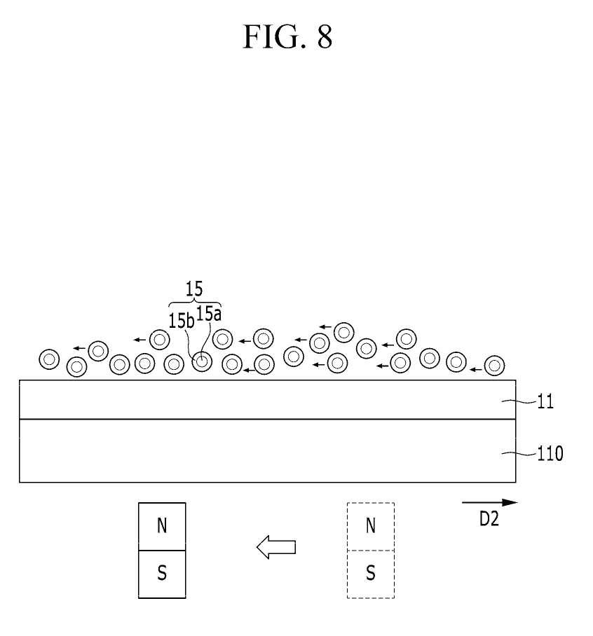

An example of forming a state in which the force is applied to the surface of the first alignment layer 11 will now be described with reference to FIG. 7 and FIG. 8.

Referring to FIG. 7, the metal particles 15 scattered on the surface of the first alignment layer 11 move depending on movement of a magnet positioned under the first substrate 110. In other words, while applying a predetermined force to the surface of the first alignment layer 11 by a magnetic force of the magnet and moving the magnet along the second direction D2, i.e. a first rubbing direction, the metal particles 15 form the plurality of grooves 13 shown in FIG. 6. In this case, as shown in FIG. 7, each of the metal particles 15 consists of a central metal particle 15a and an insulating-coating layer 15b surrounding the central metal particle 15a.

The magnet used in the present exemplary embodiment is preferably a neodymium magnet or a samarium magnet which generates a stronger magnetic force than an electrostatic attractive force caused by static electricity. However, the metal particles according to the present exemplary embodiment can perform the rubbing process within a magnetic field while being subjected to the magnetic field, and an electromagnet as a member for forming the magnetic field may be used instead of the magnet.

Referring to FIG. 8, as the magnet moves in a direction opposite to the second direction D2, i.e. a second rubbing direction, the metal particles 15 are moved to their original position while the predetermined force is applied to the surface of the first alignment layer 11. Depending on such a reciprocating motion, the plurality of grooves 13 may be formed well on the surface of the first alignment layer 11. However, instead of the reciprocating motion of the magnet, the plurality of grooves 13 may be formed by moving the magnet only in the second direction D2. In other words, the magnetic field between the first magnet movement and the second magnet movement may be removed, and additional metal particles 15 may be scattered on a region on which the initial metal particles 15 are scattered before the first magnet movement.

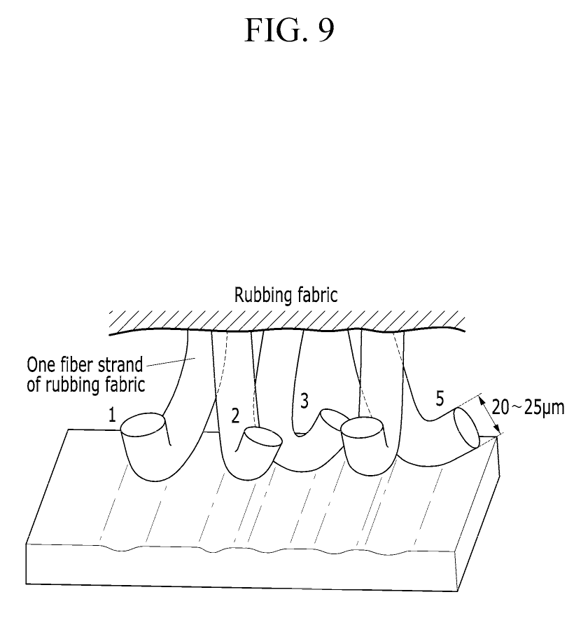

FIG. 9 illustrates a schematic perspective view of a step of rubbing with a rubbing fabric in a conventional liquid crystal display.

Referring to FIG. 9, a size of one fiber strand of the rubbing fabric used in the prior art is greater than about 20.00 μm. When one fiber strand of the rubbing fabric is formed to have a size of equal to or less than about 20.00 μm, the fiber strand of the rubbing fabric may be easily broken. The broken fiber strand sticks into the alignment layer surface to cause alignment defects.

As such, instead of the rubbing process using the rubbing fabric, by performing the rubbing process using the metal particles of a minute size as in the present exemplary embodiment, it is possible to densely and uniformly form the surface of the alignment layer. Further, in the method of using the rubbing fabric, when the rubbing fabric is wound on and bonded to a rotating roller, a minute gap between the first bonded portion and the last bonded portion may occur. The minute gap may cause an eccentric stain during the rubbing process. However, the method of using the metal particles according to the present exemplary embodiment, which does not use the rotating roller, does not cause any eccentric stain.

Referring back to FIG. 5, the manufacturing method of the liquid crystal display according to the present exemplary embodiment includes forming the second alignment layer on the second substrate (S4), and scattering the metal particles on the surface of the second alignment layer (S5).

The forming of the second alignment layer (S4) and the scattering of the metal particles (S5) may be substantially the same as described above. However, depending on strength of a magnetic field applied to an opposite surface to the surface of the second substrate on which the metal particles are scattered, a diameter of the groove formed on the surface of the second alignment layer may be different from that of the groove formed on the surface of the first alignment layer.

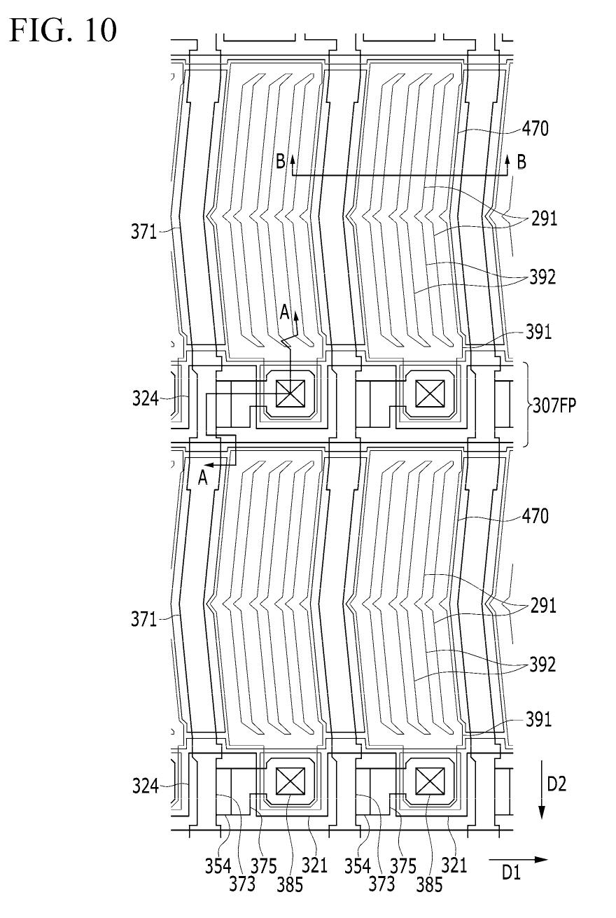

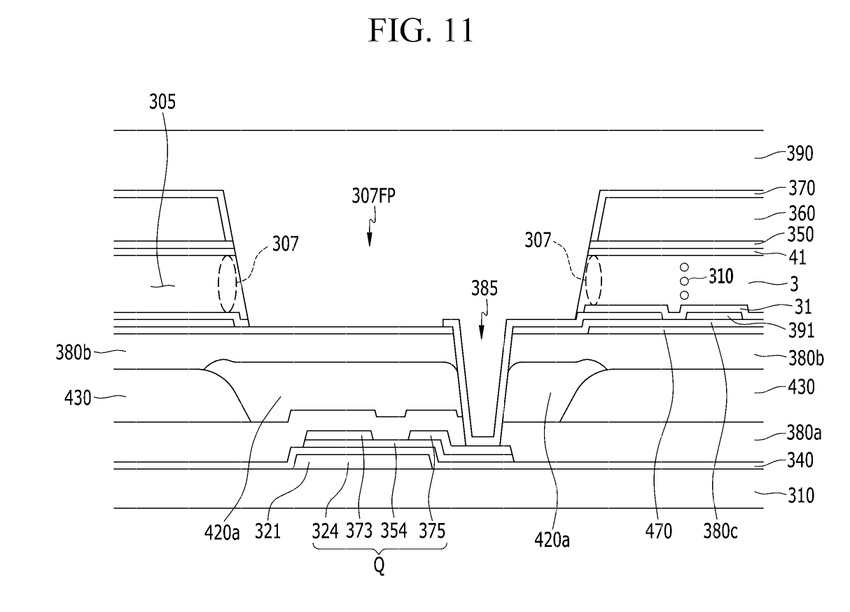

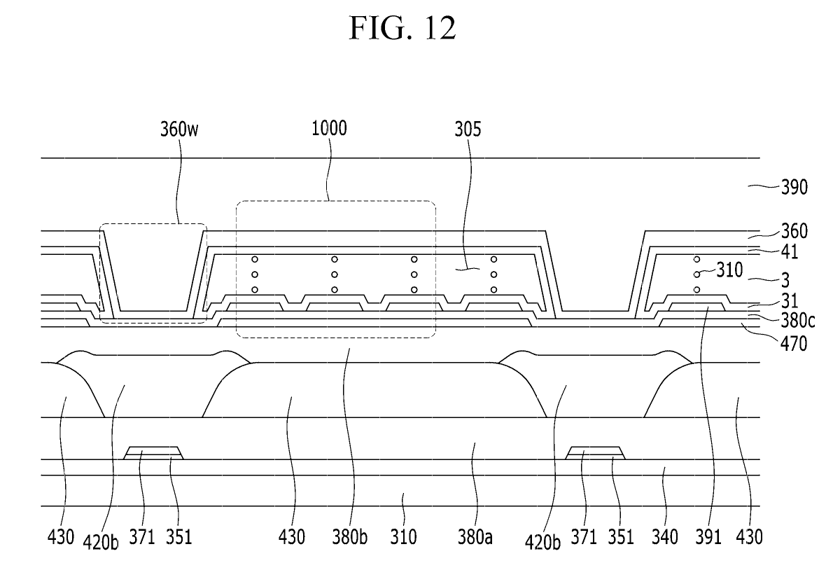

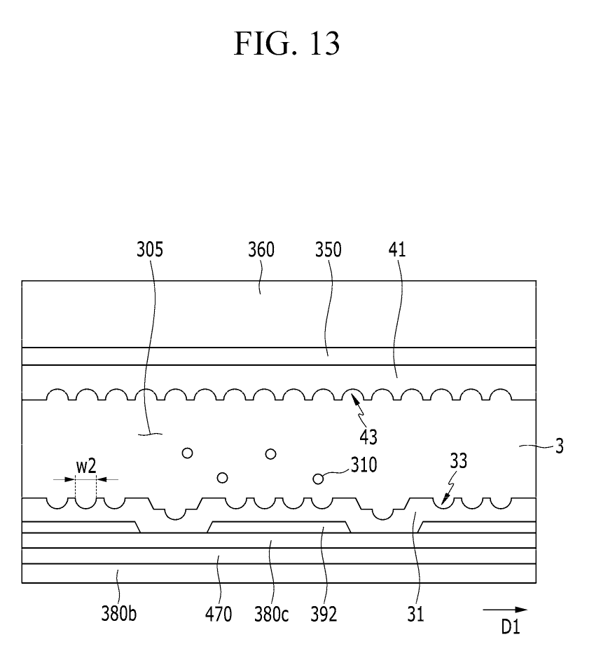

FIG. 10 illustrates a top plan view of a liquid crystal display according to an exemplary embodiment of the inventive concept. FIG. 11 illustrates a cross-sectional view of FIG. 10 taken along line A-A. FIG. 12 illustrates a cross-sectional view of FIG. 10 taken along line B-B. FIG. 13 illustrates a partial enlarged view of FIG. 12.

Referring to FIG. 10 to FIG. 12, a gate line 321 is positioned on a substrate 310 made of transparent glass or plastic. The gate line 321 includes a gate electrode 324 and a wide end portion (not shown) for connection with another layer or an external driving circuit. The gate line 321 may be made of an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, or a metal such as chromium (Cr), tantalum (Ta), titanium (Ti), etc. However, the gate line 321 may have a multilayered structure including at least two conductive layers having different physical properties.

A gate insulating layer 340 made of a silicon nitride (SiNx), a silicon oxide (SiOx), or the like is positioned on the gate line 321. The gate insulating layer 340 may have a multilayered structure including at least two insulating layers having different physical properties. A semiconductor layer 351 disposed below a data line 371, and a semiconductor layer 354 which is described later disposed under source and drain electrodes 373 and 375 and disposed in a channel portion of a thin film transistor Q, are disposed on the gate insulating layer 340. The semiconductor layer 354 may be made of amorphous silicon or polysilicon, or it may be formed of an oxide semiconductor.

A plurality of ohmic contacts may be disposed between the semiconductor layer 354 and the source and drain electrodes 373 and 375, but these are omitted in the drawings.

The data conductors including the data line 371, the source electrode 373 connected to the data line 371, and the drain electrode 375 spaced apart from the source electrode 373 are disposed on the semiconductor layer 354 and the gate insulating layer 340. The data line 371 includes a wide end portion (not shown) for connection with another layer or an external driving circuit. The data line 371 transmits a data signal and substantially extends in the vertical direction to intersect the gate line 321.

The source electrode 373 is a portion of the data line 371, and is disposed on the same line as the data line 371. The drain electrode 375 is disposed to extend in parallel with the source electrode 373. Accordingly, the drain electrode 375 is in parallel with some of the data line 371. The source electrode 373 and the drain electrode 375 may be modified without departing from the spirit of this disclosure.

The gate electrode 324, the source electrode 373, and the drain electrode 375 form a thin film transistor Q together with the semiconductor layer 354, and the channel of the thin film transistor Q is formed in the semiconductor layer between the source electrode 373 and the drain electrode 375.

The data line 371 and the drain electrode 375 may preferably be made of a refractory metal such as molybdenum, chromium, tantalum, titanium, etc., or an alloy thereof, and may have a multilayered structure in which a refractory metal layer (not shown) and a low resistance conductive layer (not shown) are included. An example of the multilayered structure may include a double layer including a chromium or molybdenum (alloy) lower layer and an aluminum (alloy) upper layer, a double layer including a titanium lower layer and a copper upper layer, and a triple layer including a molybdenum (alloy) lower layer, an aluminum (alloy) intermediate layer, and a molybdenum (alloy) upper layer.

A first passivation layer 380a is disposed on the data conductor and the exposed portion of the semiconductor layer 354. The first passivation layer 380a may include an inorganic insulating material, such as a silicon nitride (SiNx) and a silicon oxide (SiOx), or an organic insulating material.

A color filter 430 and light blocking members 420a and 420b are disposed on the first passivation layer 380a.

The light blocking members 420a and 420b are formed to have a lattice structure provided with an opening corresponding to an area for displaying an image, and are formed of a material through which light does not pass. The color filter 430 may be disposed in the opening of the light blocking members 420a and 420b. The light blocking members 420a and 420b include a horizontal light blocking member 420a disposed along a direction parallel to the gate line 321, and a vertical light blocking member 420b disposed along a direction parallel to the data line 371. However, structures of the light blocking members 420a and 420b may be modified. For example, the horizontal light blocking member 420b may be omitted, and the data line 371 may serve as the light blocking member. In addition, the horizontal light blocking member 420a may form a pixel electrode 391 described later, and may be disposed thereon.

The color filter 430 may display one of three primary colors such as red, green, and blue. However, the inventive concept is not limited to the three primary colors of red, green, and blue, and the color filter 430 may display one of cyan, magenta, yellow, and white series. The color filter 430 may be formed of materials for displaying different colors for each of the adjacent pixels.

A second passivation layer 380b for covering the color filter 430 and the light blocking members 420a and 420b may be disposed on the color filter 430 and the light blocking members 420a and 420b. The second passivation layer 380b may include an inorganic insulating material such as a silicon nitride (SiNx) and a silicon oxide (SiOx), or an organic insulating material. Unlike those illustrated in the cross-sectional view of FIG. 11, when a step occurs due to a thickness difference between the color filter 430 and the light blocking members 420a and 420b, the second passivation layer 380b may include the organic insulating material to reduce or remove the step.

The color filter 430, the light blocking members 420a and 420b, and the passivation layers 380a and 380b are provided with a contact hole 385 for exposing the drain electrode 375.

A common electrode 470 is disposed on the second passivation layer 380b. The common electrode 470 may be disposed as a whole plate on the entire substrate 310 while having a planar shape, and may be opened in a region corresponding to a periphery of the drain electrode 175 and the horizontal light blocking member 420a. That is, the common electrode 470 may have a shape of a whole plate for covering most of the pixel except for the opened portion thereof.

Common electrodes 470 disposed in adjacent pixels are connected to each other, and may receive a constant common voltage that is supplied from the outside.

An interlayer insulating layer 380c is disposed on the common electrode 470. The interlayer insulating layer 380c may be made of an organic insulating material, an inorganic insulating material, or the like.

A pixel electrode 391 is disposed on the interlayer insulating layer 380c. The pixel electrode 391 may be made of a transparent conductive material such as ITO, IZO, or the like. The pixel electrode 391 is provided with a plurality of cutouts 291, and includes a plurality of branch electrodes 392 disposed between the cutouts.

The first passivation layer 380a, the second passivation layer 380b, and the interlayer insulating layer 380c are provided with the contact hole 385 for exposing the drain electrode 375. The pixel electrode 391 is physically and electrically connected to the drain electrode 375 through the contact hole 385, and receives a voltage from the drain electrode 375.

The common electrode 470 and the pixel electrode 391 are field generating electrodes. The pixel electrode 391 and the common electrode 470 may generate a horizontal electric field or a vertical electric field. As the pixel electrode 391 and the common electrode 470, which are field generating electrodes, generate the electric field, the liquid crystal molecules 310 disposed on the two field generating electrodes 391 and 470 rotate in a direction parallel or perpendicular to the electric field. Polarization of light passing through the liquid crystal layer varies according to the rotation directions of the liquid crystal molecules 310 determined as such.

According to the liquid crystal display of the illustrated exemplary embodiment, the common electrode 470 has the flat planar shape and the pixel electrode 391 has the plurality of branch electrodes, but according to a liquid crystal display of a modified exemplary embodiment of the inventive concept, the pixel electrode 391 may have a flat planar shape and the common electrode 470 may have a plurality of branch electrodes.

A first alignment layer 31 and a second alignment layer 41 facing the first alignment layer 31 are disposed on the pixel electrode 391. A plurality of spaces 305 are disposed between the first alignment layer 31 and the second alignment layer 41, and the liquid crystal layer 3 including the liquid crystal molecules 310 is disposed in the plurality of spaces 305.

Hereinafter, the first and second alignment layers 31 and 41 according to the present exemplary embodiment will be described in detail with reference to FIG. 13. FIG. 13 illustrates an enlarged view of a partial area 1000 of FIG. 12.

Referring to FIG. 13, the first alignment layer 31 is disposed on a branch electrode 392 included in the pixel electrode 391. The second alignment layer 41 disposed facing the first alignment layer 31 is disposed on a lower insulating layer 350, and the liquid crystal layer 3 including the liquid crystal molecules 310 is disposed between the first alignment layer 31 and the second alignment layer 41.

At least one of the surface of the first alignment layer 31 facing the liquid crystal layer 3 and the surface of the second alignment layer 41 facing the liquid crystal layer 3 is provided with a plurality of grooves 33 and 43.

The grooves 33 and 43 with which the surface of the first and second alignment layers 31 and 41 are provided allow the liquid crystal molecules 310 to be horizontally aligned in a predetermined direction.

The grooves 33 and 43 according to the present exemplary embodiment may have a second width w2. The second width w2 may be in a range of about 0.05 to about 20.00 μm. However, when considering a size of a metal particle used in a manufacturing method described later in the present exemplary embodiment, it is preferable that the second width w2 is equal to or less than the cell gap of the liquid crystal layer 3. Here, the cell gap may be referred to as the thickness or height of the liquid crystal layer 3, or may be referred to as a gap between the first alignment layer 31 and the second alignment layer 41. In other words, the cell gap may be referred to as a thickness or height of a microcavity 305 formed by a space between the first alignment layer 31 and the second alignment layer 41.

In FIG. 13, it is illustrated that the width of the groove 33 of the surface of the first alignment layer 31 is equal to the width of the groove 43 of the second alignment layer 41, but it is not limited thereto, and the widths may be different from each other.

Referring to FIG. 10 and FIG. 13, a direction for defining the width w2 of the groove may be referred to as the first direction D1, and a direction crossing the first direction D1 may be referred to as the second direction D2. In FIG. 10, it is illustrated that the first direction D1 and the second direction D2 perpendicularly cross each other, but it is not limited thereto, and the first direction D1 and the second direction D2 may cross each other at an angle other than a right angle.

Referring back to FIG. 10 to FIG. 12, one side and the other side of the space 305 are provided with inlets 307. The inlets 307 are covered by a capping layer 390 described later, and they are portions through which the liquid crystal material including the alignment material and the liquid crystal molecules is injected into the space 305 by a capillary force during the manufacturing process.

The space 305 may be formed along a column direction of the pixel electrode 391, i.e., a vertical direction thereof. A roof layer 360 described later is provided with a plurality of trenches 307FP which may be covered with the capping layer 390. The capping layer 390 which covers the trenches 307FP may enable the spaces 305 adjacent to each other in the vertical direction thereof to be divided.

Each of the plurality of spaces 305 may be a microcavity corresponding to one, two, three, or more pixel areas. The pixel area means a minimum unit that may represent a contrast pixel area.

The lower insulating layer 350 is disposed on the second alignment layer 41. The lower insulating layer 350 may be made of a silicon nitride (SiNx) or a silicon oxide (SiOx).

The roof layer 360 is disposed on the lower insulating layer 350. The roof layer 360 may include a photoresist or other organic materials. However, it is not limited thereto, and may be an inorganic insulating layer made of an inorganic material such as a silicon nitride (SiNx) or a silicon oxide (SiOx). In this case, the roof layer 360 may be formed by deposition of two or more kinds of inorganic layers.

The roof layer 360 serves to support the structure of the plurality of spaces 305 so that the shape of the plurality of spaces 305 in which the liquid crystal layer is disposed may not be modified. The roof layer 360 may be disposed over the entire area on the substrate 310 excluding the trenches 307FP.

An upper insulating layer 370 is disposed on the roof layer 360. The upper insulating layer 370 may contact a top surface of the roof layer 360. The upper insulating layer 370 may be made of a silicon nitride (SiNx) or a silicon oxide (SiOx).

The capping layer 390 is disposed on the upper insulating layer 370. The capping layer 390 may include an organic material or an inorganic material. Specifically, the capping layer 390 may be formed of a thermosetting resin, a silicon oxycarbide (SiOC), a graphene, etc. The capping layer 390 of the present exemplary embodiment may contact a top surface of the upper insulating layer 370. The capping layer 390 may cover the trenches 307FP of the roof layer 360 as well as an upper portion of the upper insulating layer 370. In this case, the capping layer 390 may cover the inlet 307 of the space 305 exposed by the trench 307FP after the liquid crystal material is injected thereto. In the present exemplary embodiment, it is illustrated that the liquid crystal material is removed from the trench 307FP of the roof layer 360, but a remaining liquid crystal material after being injected into the space 305 may remain in the trench 307FP.

In the present exemplary embodiment, a partition wall 360w is disposed between the spaces 305 adjacent to each other in the first direction D1, as shown in FIG. 12. The partition wall 360w partitions the spaces 305 adjacent to each other in the direction in which the gate line 121 extends. The partition wall 360w may be an extending portion of the roof layer 360 that supports the space 305 and that extends and is filled between the spaces 305. The partition wall 360w may be disposed along the direction in which the data line 371 extends, or in the second direction D2.

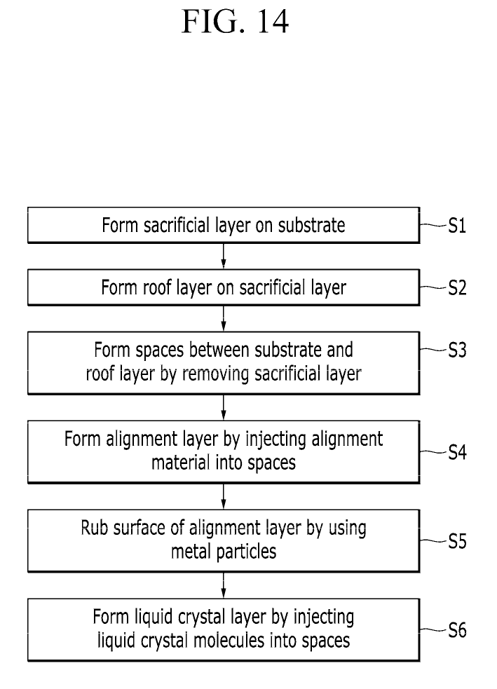

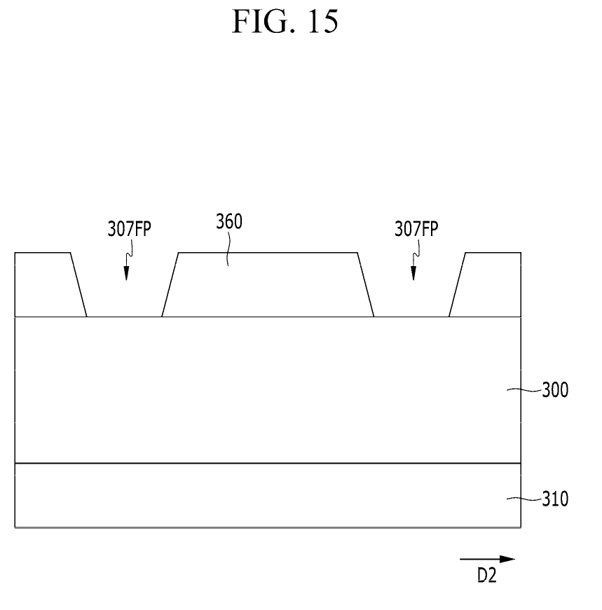

FIG. 14 illustrates a flowchart of a manufacturing method of a liquid crystal display according to an exemplary embodiment of the inventive concept. FIG. 15 to FIG. 20 illustrate cross-sectional views of a manufacturing method of a liquid crystal display according to an exemplary embodiment of the inventive concept.

Referring to FIG. 14, a manufacturing method of a liquid crystal display according to an exemplary embodiment of the inventive concept includes forming a sacrificial layer on the substrate (S1).

More specifically, as shown in FIG. 10 to FIG. 12, in order to form the generally-known switching element on the substrate 310, the gate line 321 extending in the horizontal direction is formed on the substrate 310, the gate insulating layer 340 is formed on the gate line 321, the semiconductor layer 354 is formed on the gate insulating layer 340, and then the source electrode 373 and drain electrode 375 are formed. In this case, the data line 371 connected to the source electrode 373 may be formed to cross the gate line 321 and extend in the vertical direction.

The first passivation layer 380a is formed on the data conductor including the source electrode 373, the drain electrode 375, and the data line 371, and the exposed semiconductor layer 354.

The color filter 430 and the light blocking members 420a and 420b are formed on the first passivation layer 380a, and then the second passivation layer 380b is formed thereon. The common electrode 470 is formed on the second passivation layer 380b, and then the interlayer insulating layer 380c is formed thereon. The contact hole 385 penetrating through the first passivation layer 380a, the second passivation layer 380b, and the interlayer insulating layer 380c is then formed. Next, the pixel electrode 391 is formed on the interlayer insulating layer 380c, and the pixel electrode 391 may be physically and electrically connected to the drain electrode 375 through the contact hole 385.

Subsequently, the sacrificial layer 300 is formed on the pixel electrode 391. In this case, the sacrificial layer 300 is provided with an opening portion (not shown) along the second direction D2. The opening portion is a portion that is covered by a roof layer described later such that the partition wall is formed. The sacrificial layer 300 may be formed of a photoresist or the organic material.

Referring to FIG. 14 and FIG. 15, the manufacturing method of the liquid crystal display according to the present exemplary embodiment further includes forming the roof layer 360 on the sacrificial layer 300 (S2).

The roof layer 360 is partially removed along the first direction D1 to form the trench 307FP and expose the sacrificial layer 300. Although not illustrated, in the forming of the roof layer 360 to be partially removed to form the trench 307FP, the lower insulating layer 350 and the common electrode 470 disposed under the roof layer 360 and the upper insulating layer 370 on the roof layer 360 may be partially removed.

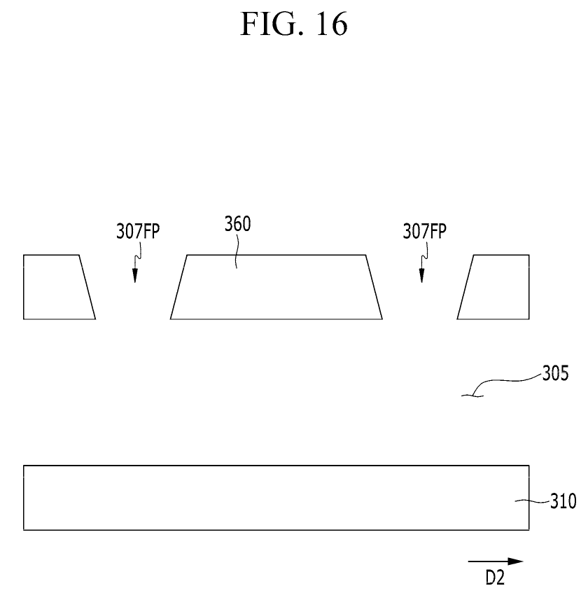

Referring to FIG. 14 and FIG. 16, the manufacturing method of the liquid crystal display according to the present exemplary embodiment includes forming the plurality of spaces 305 between the substrate 110 and the roof layer 360 by removing the sacrificial layer 300 (S3).

The sacrificial layer 300 is removed by an oxygen ashing process, a wet etching process, or the like through the trench 307FP. In this case, the plurality of spaces 305 with the inlet 307 are formed, as shown in FIG. 11. The space 305 is empty because the sacrificial layer 300 is removed. The inlet 307 of FIG. 11 may be formed along the first direction D1.

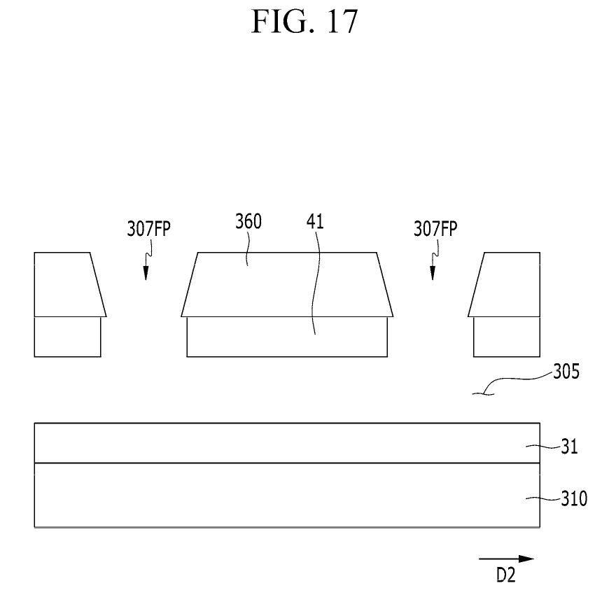

Referring to FIG. 14 and FIG. 17, the manufacturing method of the liquid crystal display according to the present exemplary embodiment includes forming the alignment layers 31 and 41 by injecting the alignment material into the plurality of spaces 305 (S4).

Specifically, a bake process is performed after injecting the aligning material containing a solid content and a solvent through the trench 307FP.

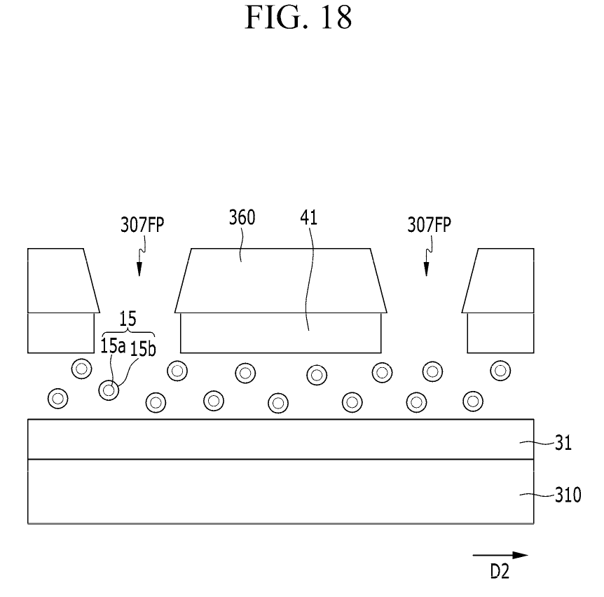

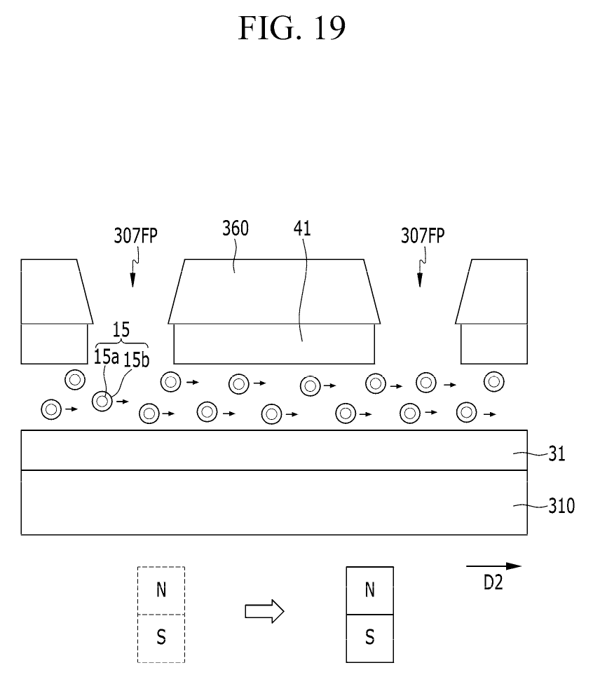

Referring to FIG. 14, FIG. 18, and FIG. 19, the manufacturing method of the liquid crystal display according to the present exemplary embodiment includes rubbing the surfaces of the alignment layers 31 and 41 by using the plurality of metal particles 15 (S5).

In FIG. 18, the plurality of metal particles 15 are injected through the trench 307FP and scattered in the plurality of spaces 305.

In FIG. 19, the metal particles 15 scattered on the surfaces of the first alignment layer 31 and the second alignment layer 41 move together with the magnet according to the movement of the magnet positioned under the substrate 310. In other words, while applying a predetermined force to the surfaces of the first and second alignment layers 31 and 41 by the magnetic force of the magnet and moving along the second direction D2, the metal particles 15 form the plurality of grooves 33 and 43 shown in FIG. 13. In this case, as shown in FIG. 19, each of the metal particles 15 consists of a central metal particle 15a and an insulating-coating layer 15b surrounding the central metal particle 15a.

Here, the magnet employed is preferably a neodymium magnet or a samarium magnet which generates a stronger magnetic force than an electrostatic attractive force caused by static electricity. However, the metal particles according to the present exemplary embodiment can perform the rubbing process within a magnetic field while being subjected to the field, and an electromagnet instead of the magnet may be used for forming the magnetic field.

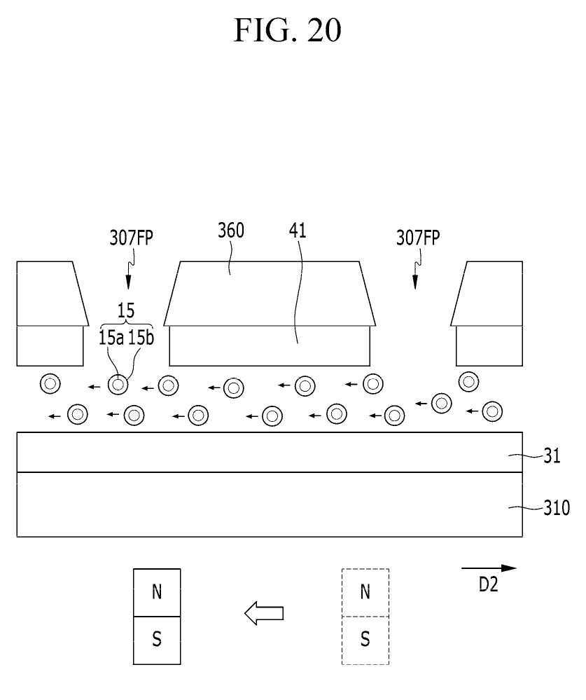

Referring to FIG. 20, as the magnet moves in a direction opposite to the second direction D2, the metal particles 15 are moved to their original position while the predetermined force is applied to the surfaces of the first and second alignment layers 31 and 41. Depending on such a reciprocating motion, the plurality of grooves 33 and 43 of FIG. 13 may be formed well on the surfaces of the first and second alignment layers 31 and 41. However, instead of the reciprocating motion of the magnet, the plurality of grooves 33 and 43 may be formed by moving the magnet only in the second direction D2. In other words, the magnetic field between the first magnet movement and the second magnet movement may be removed, and additional metal particles 15 may be scattered on a region on which the initial metal particles 15 are scattered before the first magnet movement.

Since the second alignment layer 41 is further apart than the first alignment layer 31 from a region in which the magnetic field is generated according to the present exemplary embodiment, less magnetic force is applied to the second alignment layer 41. Accordingly, the width of the groove 33 formed on the surface of the first alignment layer 31 may be greater than that of the groove 43 formed on the surface of the second alignment layer 41.

Referring back to FIG. 14, the manufacturing method of the liquid crystal display according to the present exemplary embodiment includes forming the liquid crystal layer 3 by injecting the liquid crystal material containing the liquid crystal molecules into the plurality of spaces 305 (S6).

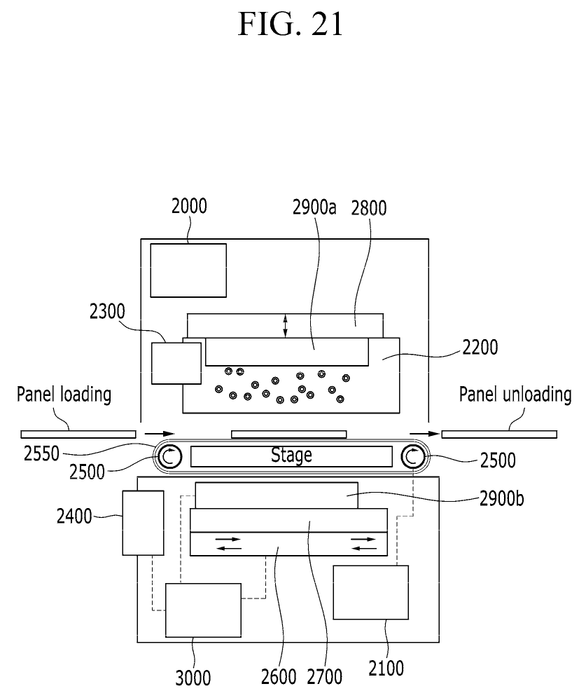

FIG. 21 illustrates an exemplary view of a manufacturing apparatus for performing the manufacturing method of the liquid crystal display according to the exemplary embodiment of the inventive concept.

Referring to FIG. 21, the manufacturing apparatus for manufacturing the liquid crystal display according to the exemplary embodiment of the inventive concept includes an upper region and a lower region based on a stage. The upper region includes an upper power supply device 2000, a position adjuster 2800, an electromagnet 2900a, a particle supplier 2300, and a particle scattering unit 2200. The lower region includes a lower power supply device 3000, a balance maintainer 2700, an electromagnet 2900b, and a reciprocating device 2600. Here, a conveyor belt 2550 surrounding the stage and a rotating roll 2500 for rotating the conveyor belt are further included. The rotating roll 2500 may be rotated depending on control by a rotating roll controller 2100.

The manufacturing method of the liquid crystal display according to the exemplary embodiment of the inventive concept which is performed by the manufacturing apparatus will now be simply described.

The display panel provided with the alignment layer moves over the stage. The conveyor belt 2550 and the rotating roll 2500 move the display panel over the stage. Metal particles supplied from the particle supplier 2300 are fed into the particle scattering unit 2200, and the electromagnet 2900a prevents the injected metal particles from dropping down to the stage. When the display panel moves over the stage to be prepared, power applied to the electromagnet 2900a of the upper region is turned off, such that the plurality of metal particles in the particle scattering unit 2200 may be scattered on the display panel. A magnetic field is generated by the electromagnet 2900b of the lower region by the power supply device 3000, and the electromagnet 2900b moves by the reciprocating device 2600. Depending on movement of the electromagnet 2900b, the metal particles move while applying a predetermined force to the surface of the alignment layer on the display panel. The grooves may be formed well depending on the rubbing of the metal particles by the reciprocating device 2600.

The position adjuster 2800 of the upper region may adjust the scattering of the metal particles, and the balance maintainer 2700 of the lower region may serve to maintain balance of the stage to form uniform grooves.

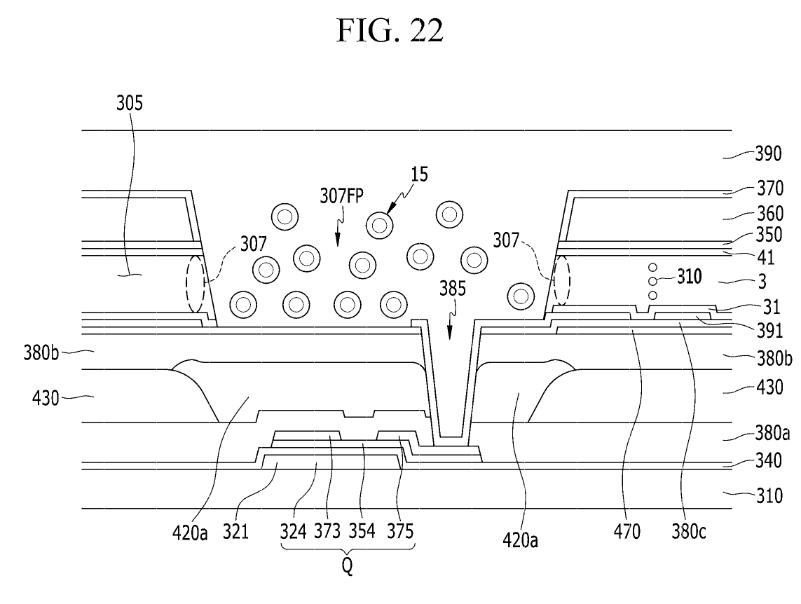

FIG. 22 illustrates a cross-sectional view of a modified embodiment with respect to the exemplary embodiment of FIG. 10 to FIG. 13.

The exemplary embodiment to be described in FIG. 22 is mostly the same as the exemplary embodiment described in FIG. 10 to FIG. 13. Accordingly, descriptions of the same constituent elements will be omitted, and detailed descriptions of different constituent elements will be provided.

Referring to FIG. 22, metal particles 15 remain in the trench 307FP covered by the capping layer 390. The metal particles 15 may prevent contamination of the liquid crystal molecules 310 due to contacts between the materials forming the liquid crystal molecules 310 and the capping layer 390. In addition, by forming the metal particles 15 with a light blocking material, a light blocking member for covering a portion corresponding to the thin film transistor Q may be omitted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A manufacturing method of a liquid crystal display, comprising:
forming an alignment layer on a substrate; and
rubbing a surface of the alignment layer with a plurality of metal particles.

2. The manufacturing method of the liquid crystal display of claim 1, wherein
the rubbing of the surface of the alignment layer with the plurality of metal particles is performed within a magnetic field.

3. The manufacturing method of the liquid crystal display of claim 2, wherein
the rubbing of the surface of the alignment layer with the plurality of metal particles includes forming a plurality of grooves on the surface of the alignment layer.

4. The manufacturing method of the liquid crystal display of claim 3, wherein
at least one of the metal particles has a diameter of about 0.05 to about 20.00 μm.

5. The manufacturing method of the liquid crystal display of claim 3, wherein
at least one of the metal particles includes a ferromagnetic material.

6. The manufacturing method of the liquid crystal display of claim 3, wherein
at least one of the metal particles includes at least one selected from iron, nickel, cobalt, iron oxide, chromium oxide, and ferrite.

7. The manufacturing method of the liquid crystal display of claim 3, wherein
at least one of the metal particles is coated for insulation.

8. The manufacturing method of the liquid crystal display of claim 2, wherein
the rubbing of the surface of the alignment layer with the plurality of metal particles includes moving a magnetic field generating member generating a magnetic field along a first rubbing direction.

9. The manufacturing method of the liquid crystal display of claim 8, wherein
the rubbing of the surface of the alignment layer with the plurality of metal particles further includes moving the magnetic field generating member in a second rubbing direction.

10. The manufacturing method of the liquid crystal display of claim 1, wherein
the forming of the alignment layer on the substrate includes forming a first alignment layer on a first substrate and forming a second alignment layer on a second substrate,
the rubbing of the surface of the alignment layer with the plurality of metal particles includes rubbing a surface of the first alignment layer with the plurality of metal particles and rubbing a surface of the second alignment layer with the plurality of metal particles, and
the manufacturing method of the liquid crystal display further comprises disposing the first substrate and the second substrate to face each other and forming a liquid crystal layer between the first substrate and the second substrate.

11. The manufacturing method of the liquid crystal display of claim 1, further comprising:
forming a sacrificial layer on the substrate;
forming a roof layer on the sacrificial layer;
forming a plurality of spaces between the substrate and the roof layer by removing the sacrificial layer;
forming the alignment layer by injecting an alignment material into the plurality of spaces; and
forming a liquid crystal layer by injecting liquid crystal molecules into the plurality of spaces,
wherein the rubbing of the surface of the alignment layer with the plurality of metal particles is performed before the forming of the liquid crystal layer.

12. The manufacturing method of the liquid crystal display of claim 11, wherein
the rubbing of the surface of the alignment layer with the plurality of metal particles is performed within a magnetic field.

13. The manufacturing method of the liquid crystal display of claim 12, wherein
the rubbing of the surface of the alignment layer with the plurality of metal particles includes forming a plurality of grooves on the surface of the alignment layer.

14. The manufacturing method of the liquid crystal display of claim 13, wherein
a diameter of at least one of the metal particles is equal to or less than a cell gap of the liquid crystal layer.

15. The manufacturing method of the liquid crystal display of claim 13, wherein
at least one of the metal particles includes a ferromagnetic material.

16. The manufacturing method of the liquid crystal display of claim 13, wherein
at least one of the metal particles includes at least one selected from iron, nickel, cobalt, iron oxide, chromium oxide, and ferrite.

17. The manufacturing method of the liquid crystal display of claim 13, wherein
at least one of the metal particles is coated for insulation.

18. The manufacturing method of the liquid crystal display of claim 11, wherein
the rubbing of the surface of the alignment layer with the plurality of metal particles includes moving a magnetic field generating member generating the magnetic field along a first rubbing direction.

19. The manufacturing method of the liquid crystal display of claim 18, wherein
the rubbing of the surface of the alignment layer with the plurality of metal particles further includes moving the magnetic field generating member in a second rubbing direction.

20. A liquid crystal display, comprising:
a first alignment layer disposed on a first substrate;
a second substrate facing the first substrate;
a liquid crystal layer disposed between the first substrate and the second substrate; and
a second alignment layer disposed between the liquid crystal layer and the second substrate,
wherein a surface of at least one selected from the first alignment layer and the second alignment layer has a plurality of grooves, and
wherein at least one of the grooves has a width of about 0.05 to about 20.00 μm.

21. The liquid crystal display of claim 20, wherein
the width of the at least one of the grooves is equal to or less than a cell gap of the liquid crystal layer.

22. The liquid crystal display of claim 21, wherein
the surface of the first alignment layer and the surface of the second alignment layer each has at least one groove, and
wherein a width of the at least one groove of the surface of the first alignment layer is different from a width of the at least one groove of the surface of the second alignment layer.

23. The liquid crystal display of claim 21, further comprising:
a first electrode disposed on the first substrate;
a second electrode spaced apart from the first electrode; and
an insulating layer between the first electrode and the second electrode.

24. The liquid crystal display of claim 20, wherein
each of the grooves has a uniform width.

25. A liquid crystal display, comprising:
a first alignment layer disposed on a substrate;
a second alignment layer overlapping the first alignment layer;
a roof layer disposed on a second alignment layer; and
a liquid crystal layer including liquid crystal molecules disposed in a plurality of spaces between the first alignment layer and the second alignment layer,
wherein a surface of at least one selected from the first alignment layer and the second alignment layer has a plurality of grooves.

26. The liquid crystal display of claim 25, wherein
a width of at least one of the grooves is in a range of about 0.05 to about 20.00 μm.

27. The liquid crystal display of claim 25, wherein
a width of at least one of the grooves is equal to or less than a cell gap of the liquid crystal layer.

28. The liquid crystal display of claim 25, wherein
the surface of the first alignment layer and the surface of the second alignment layer each has at least one groove, and
a width of the at least one groove of the surface of the first alignment layer is different from a width of the at least one groove of the surface of the second alignment layer.

29. The liquid crystal display of claim 28, wherein
the width of the at least one groove of the surface of the first alignment layer is greater than the width of the at least one groove of the surface of the second alignment layer.

30. The liquid crystal display of claim 25,
wherein the roof layer is a first roof layer defining a first space of the plurality of spaces, further comprising:
a second roof layer adjacent to the first roof layer defining a second space of the plurality of spaces, and
a trench formed between the first space and the second space, wherein metal particles are positioned in the trench.

31. The liquid crystal display of claim 30, further comprising:
a capping layer disposed on the roof layer,
wherein the capping layer covers the trench.

32. The liquid crystal display of claim 25, further comprising:
a common electrode disposed on the substrate;
a pixel electrode spaced apart from the common electrode; and
an insulating layer disposed between the pixel electrode and the common electrode.
